(19) United States
(12) Patent Application Publication
(10) Pub. No.: US 2017/0349282 A1
(43) Pub. Date: Dec. 7, 2017

(54) Unmanned Aerial Vehicle Apparatus and Method

(71) Applicant: Wal-Mart Stores, Inc., Bentonville, AR (US)

(72) Inventors: John P. Thompson, Bentonville, AR (US); Donald R. High, Noel, MO (US); Brian G. McHale, Chadderton Oldham (GB); Gregory A. Hicks, Rogers, AR (US); David C. Winkle, Bella Vista, AR (US); Robert C. Taylor, Rogers, AR (US)

(21) Appl. No.: 15/612,494

(22) Filed: Jun. 2, 2017

Related U.S. Application Data
(60) Provisional application No. 62/345,542, filed on Jun. 3, 2016.

(51) Int. Cl. B64C 39/02; G06Q 10/08; H04L 12/58

(52) U.S. Cl. CPC B64C 39/024; H04L 51/32; G06Q 10/083; B64C 2201/128

(57) ABSTRACT

At least one unmanned aerial vehicle operates in conjunction with a control circuit via a network interface. The control circuit receives informational content from the unmanned aerial vehicle and automatically processes that informational content to identify specific content of interest. The control circuit then automatically submits that identified specific content to at least one social networking service to thereby publicly share that content as social media.

### RELATED APPLICATION(S)

This application claims the benefit of U.S. Provisional Application No. 62/345,542, filed Jun. 3, 2016, which is incorporated herein by reference in its entirety.

### TECHNICAL FIELD

These teachings relate generally to unmanned aerial vehicles.

### BACKGROUND

Unmanned aerial vehicles (often referred to colloquially as drones) hold considerable potential. In addition to offering a recreational outlet, proposed non-military uses for unmanned aerial vehicles include professional/commercial photography and videography, package deliveries, environmental quantification and testing, and so forth.

Many drones are equipped with wireless communications capabilities. Such a drone is able to receive messages and/or transmit data during flight and often in real time or near real time. At present, such messages are usually transmitted using a corresponding format/methodology (many of which are proprietary and not generally accessible).

Accordingly, a large body of data being acquired (or that is acquirable) by an increasing number of drones is typically not generally available to a large population of potentially interested persons, and certainly not while the drone is in flight, with exceptions being typified by very direct communication links between the drone and the point of presentation.

### BRIEF DESCRIPTION OF THE DRAWINGS

The above needs are at least partially met through provision of the unmanned aerial vehicle apparatus and method described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a call flow diagram as configured in accordance with various embodiments of these teachings;

FIG. 4 comprises a block diagram as configured in accordance with various embodiments of these teachings;

FIG. 5 comprises a block diagram as configured in accordance with various embodiments of these teachings; and

FIG. 6 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, at least one unmanned aerial vehicle operates in conjunction with a control circuit via a network interface. The control circuit receives informational content from the unmanned aerial vehicle and automatically processes that informational content to identify specific content of interest. The control circuit then automatically submits that identified specific content to at least one social networking service to thereby publicly share that content as social media.

The unmanned aerial vehicle can be ordinarily tasked with a variety of other unrelated activities (i.e., a primary task that is other than gathering such content). By one approach, for example, the unmanned aerial vehicle comprises a package delivery service vehicle that ordinarily delivers packages on behalf of a retail shopping service.

These teachings will accommodate handling a wide variety of informational content per the foregoing. Examples include but are not limited to textual content, still-image content, video content, audio content, atmospheric-conditions content, and so forth.

By one approach the control circuit processes the informational content to identify the specific content of interest as a function of selection criteria. If desired, the aforementioned social networking service provides at least some of that selection criteria. So configured, a user of the social networking service may task one or more unmanned aerial vehicles with gathering and providing informational content of interest.

By one approach, when the control circuit submits the aforementioned specific content to a social networking service, the control circuit may submit that content on behalf of the unmanned aerial vehicle (for example, to accommodate a situation where the unmanned aerial vehicle has an individualized presence on the social networking service).

These teachings are highly flexible in practice and will accommodate a wide variety of modifications. As one illustrative example in these regards, the control circuit may receive informational content from each of a plurality of unmanned aerial vehicles and thereafter submit specific content from more than just one of the unmanned aerial vehicles to the social networking service as aggregated social media.

So configured, these teachings permit the presence and sensing/information-gathering capabilities of any number of unmanned aerial vehicles to be leveraged in a way that permits any number of other interested parties to share gathered information. These capabilities can in turn facilitate any number of educational, security, commercial, and other purposes.

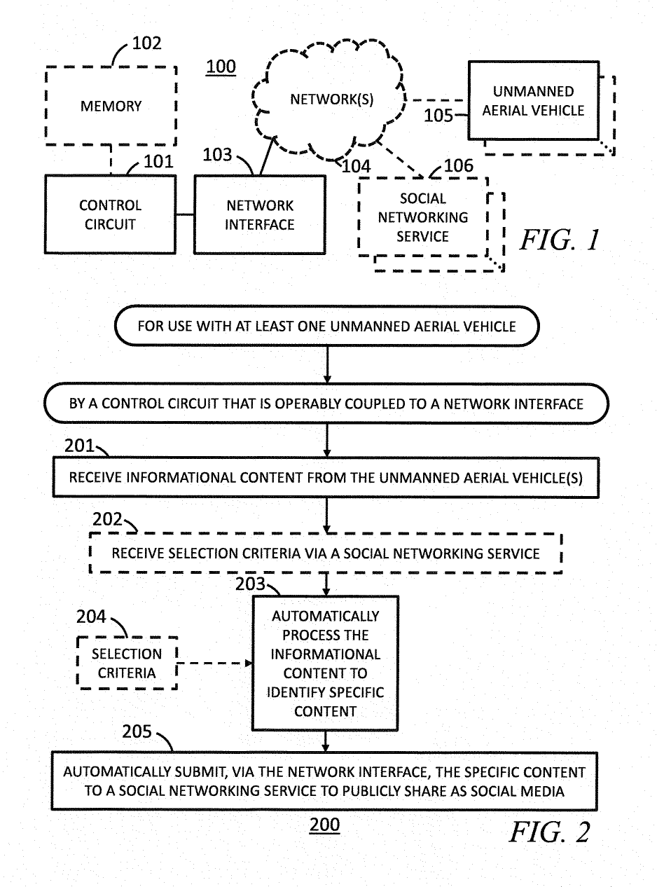

These and other benefits should become more evident upon making a thorough review of the following detailed description. FIG. 1 presents an example of an enabling apparatus 100. In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to other information as described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 101 also operably couples to a network interface 103. So configured the control circuit 101 can communicate with other elements (both within the apparatus 100 and external thereto) through one or more networks 104 (such as the Internet and/or one or more wireless data networks) via the network interface 103. Network interfaces, including both wireless and non-wireless platforms, are well understood in the art and require no particular elaboration here.

In this example the control circuit 101 is communicatively coupled to at least one unmanned aerial vehicle 105 by way of the network interface 103. Unmanned aerial vehicles are a well understood though currently growing field of endeavor. Further elaboration regarding the configuration of such a vehicle appears further herein.

That said, in this illustrative example the unmanned aerial vehicle 105 is presumed to itself have a control circuit that can communicate with the aforementioned control circuit 101 via an on-board network interface. The unmanned aerial vehicle 105 may also include one or more on-board cameras and/or sensors that sense or otherwise respond to one or more conditions or circumstances that the unmanned aerial vehicle's control circuit can employ to develop informational content. Examples in these regards include but are not limited to still-image cameras, video cameras, atmospheric-content sensors (such as thermometers, humidistats, pollution sensors, and so forth), cameras having sensitivity to various non-visible light spectra of interest (and hence capable, for example, of capturing thermal images), thermal sensors, audio input devices such as microphones, and so forth.

As will be described in more detail below, these teachings leverage the capabilities of the unmanned aerial vehicle 105 by ultimately sharing informational content captured and/or developed by the unmanned aerial vehicle 105. By one approach, however, such tasks need not represent the primary or ordinary tasking for the unmanned aerial vehicle 105. For example, by one approach the unmanned aerial vehicle 105 comprises a package delivery service vehicle that ordinarily delivers packages on behalf of a retail shopping service (such as an on-line service or a service provided by a physical retail shopping facility).

FIG. 1 also illustrates that this apparatus 100 operates in conjunction with one or more social networking services 106. For example, the control circuit 101 may communicate as described herein with a social networking service 106 via the aforementioned network interface 103. The present teachings are highly flexible in practice and will accommodate a variety of social networking services including but not limited to Twitter, Facebook, Interest, Vine, YouTube, Instagram, Tumblr, and so forth. As used herein, a “social networking service” will be understood to constitute a service designed to build social networks/relations amongst people who share similar interests, activities, backgrounds, or real-life connections by supporting user-created service-specific profiles that are maintained and offered publicly by the service and that promote the posting and sharing of user-generated content. Although the present teachings could be employed in conjunction with email services, short message services (SMS), and the like, it will be understood that a “social networking service” does not refer specifically to such communication services.

FIG. 2 presents a process 200 that can be employed by such an apparatus 100 and, more specifically, that can be employed for use with at least one unmanned aerial vehicle 105 and carried out by a control circuit 101 that is operably coupled to a network interface 103 as described above.

At block 201 the control circuit 101 receives informational content (via, for example, the network interface 103) from one or more of the unmanned aerial vehicles 105. This activity may comprise, for example, receiving that informational content via a wireless transmission and while the unmanned aerial vehicle 105 is airborne (and also while that unmanned aerial vehicle 105 is tasked with a primary activity such as delivering a package to a recipient address that is not an information-gathering activity that resulted in the transmitted content). These teachings will accommodate a wide variety of informational content. Examples include but are not limited to textual content, still-image content, video content, audio content, and/or atmospheric-conditions content.

By one approach the unmanned aerial vehicle 105 gathers such informational content on a scheduled basis (such as every five minutes). By another approach, in lieu of the foregoing or in combination therewith, the unmanned aerial vehicle 105 gathers such informational content in response to some non-temporal event. For example, the unmanned aerial vehicle 105 may capture a still image for each 100 meters of horizontal flight.

The particular informational content gathered and so provided by the unmanned aerial vehicle 105 can vary with the application setting as desired. By one approach the unmanned aerial vehicle 105 is preprogrammed to collect and forward one or more particular kinds of content. By another approach, the unmanned aerial vehicle 105 may be configured to receive in-flight instructions regarding informational content to be gathered and/or forwarded as described.

At optional block 202 the control circuit 101 receives selection criteria via a social networking service 106. So configured, for example, a user of the social networking service 106 may provide an instruction or request that the social networking service 106 forwards to the control circuit 101 and that the latter treats as selection criteria.

At block 203 the control circuit 101 automatically processes the informational content received from the one or more unmanned aerial vehicles 105 to identify specific content of interest. By one approach the control circuit 101 processes the informational content as a function, at least in part, of selection criteria 204. The selection criteria 204 may be relatively static or dynamic as desired, and may include or constitute the selection criteria optionally received from a social networking service 106 as described above.

As one illustrative example in these regards, the selection criteria may represent ambient temperatures at a particular geographic location. In that case the control circuit 101 may use that selection criteria to identify received informational content from one or more unmanned aerial vehicles 105 that represent ambient temperatures at that location.

In addition to the foregoing, the control circuit 101 may process the identified specific content to either ensure compatible reception of that content by an intended social networking service and/or compatible usage of that content by the intended social networking service. As one simple example in these regards, a social networking service may require no more than a particular level of resolution for posted images. In that case, the control circuit 101 may process images received from the unmanned aerial vehicle 105 that comprise part of the identified specific content to not exceed such resolution limitations.

At block 205, the control circuit 101 automatically submits, via the network interface 103, the identified specific content to a particular social networking service 106 (or social networking services) to thereby publicly share that specific content as social media. By one approach the control circuit 101 submits the content at regular predetermined intervals and/or a predetermined number of times per day.

These teachings will accommodate having individual unmanned aerial vehicles 105 (or a particular specific fleet of such unmanned aerial vehicles 105 such as all unmanned aerial vehicles 105 that offer delivery service for a particular retail shopping facility) having an individualized presence on such a social networking service 106 (for example, a Facebook page for a particular individual drone). In that case, when automatically submitting the specific content the control circuit 101 can specifically submit the specific content to the social networking service 106 on behalf of the unmanned aerial vehicle(s) such that it appears at the social networking service 106 that the unmanned aerial vehicle itself updated its own individualized presence at that service by posting the specific content of interest.

As already noted above these teachings will accommodate receiving information from a plurality of unmanned aerial vehicles and submitting content provided by more than one of those unmanned aerial vehicles in an aggregated form. In such a case, the above-described submission of the specific content to the social networking service 106 can serve to publicly share that combined content as aggregated social media via that social networking service.

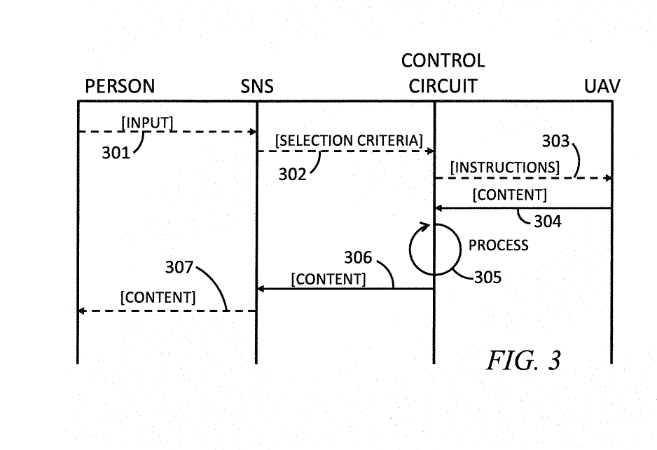

FIG. 3 presents a simple illustrative example in the foregoing regards. In this example a person interacts with their social networking service (for example, via their mobile device, their pad/tablet-style device, their laptop computer, or other device of choice) by inputting 301 a choice or by entering information that the social networking service in turn forwards (either in an original form or in a translated form) to the aforementioned control circuit 101 as selection criteria 302. For example, the person may have identified a geographic area by entering an address or by identifying a particular area on a displayed map and the person may also have selected a particular kind of content such as an aerial view or current weather conditions. In that case, the selection criteria 302 provided by the social networking service to the control circuit would comprise at least in part those criteria.

In this example the control circuit 101 responsively forwards instructions 303 to at least one unmanned aerial vehicle 105. Those instructions 303 might comprise the selection criteria 302 themselves or might constitute instructions for particular information-gathering behaviors and triggers for those behaviors that are designed to accommodate or implement the selection criteria 302. For example, and presuming to continue the example provided immediately above, the instructions 303 may require the unmanned aerial vehicle 105 to capture images and/or take temperature readings when located within the designated geographic area.

In any event, whether responding to such instructions or otherwise, the unmanned aerial vehicle 105 transmits its content 304 to the control circuit 101. The control circuit 101 processes 305 that content as described above and automatically forwards the identified specific content 306 to the corresponding social networking service 106. In this example the social networking service 106 then shares that content 307 with, for example, a person who may have requested content corresponding to the above described input parameters 301.

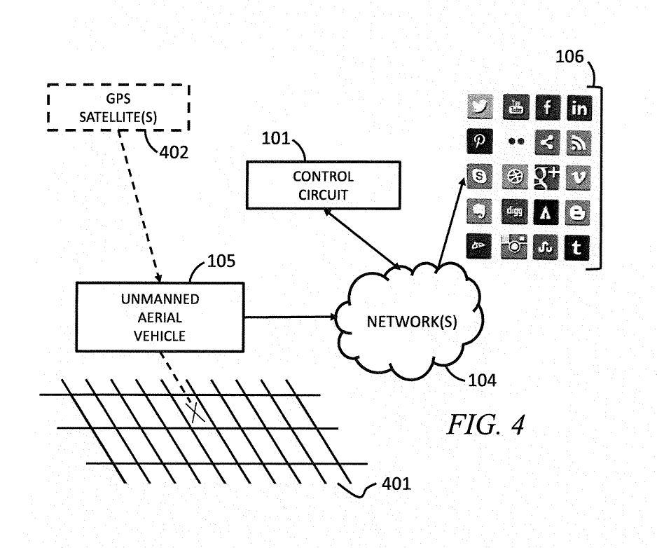

FIG. 4 presents another illustrative example. In this example the unmanned aerial vehicle 105 is secondarily tasked with gathering a particular kind of information (such as one or more images, particular items of environmental data, or the like) at a particular geographic location denoted by an “X” in this figure. As the unmanned aerial vehicle 105 traverses the underlying terrain 401 the unmanned aerial vehicle 105 also receives global positioning system information from one or more GPS satellites 402 and hence is aware of its own location.

When the unmanned aerial vehicle 105 reaches the designated geographic location X the unmanned aerial vehicle 105 captures/collects the desired information and transmits that information via the network(s) 104 to the control circuit 101 as described above. The latter then processes the received information and responsively forwards the appropriate information to one or more social networking services 106 where the information is shared as though the information were being shared directly by the unmanned aerial vehicle 105 via a corresponding presence at the social networking service 106.

These teachings are very flexible and can be modified in various ways to accommodate any number of other needs and circumstances. By one approach, for example, these teachings can be implemented to protect privacy and/or security concerns of particular individuals or institutions. Concerned parties may, for example, opt out of having one or more kinds of informational content be obtained and/or shared via such a system. As another approach, no content gathered in such a manner might be shared absent the relevant party's express permission.

So configured, a possibly large population of unmanned aerial vehicles (which are perhaps airborne for a variety of corresponding primary purposes) can be leveraged to support a myriad of secondary considerations via a social networking presence.

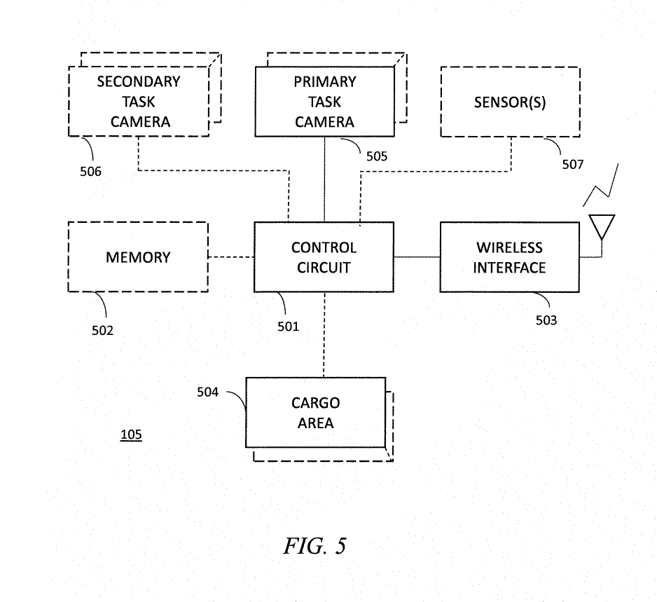

FIG. 5 presents a more detailed view of an exemplary unmanned aerial vehicle 105. In this example the unmanned aerial vehicle 105 includes a control circuit 501 (comprising, for example, a control circuit platform as described above in FIG. 1). When this control circuit 501 comprises a programmable platform the unmanned aerial vehicle 105 can further include a memory 502 (comprising, for example, a memory platform as described above in FIG. 1) that contains, for example, the instructions that the control circuit 501 executes to control the various actions and reactions of the unmanned aerial vehicle 105.

In this example the control circuit 501 also operably couples to a wireless interface 503. The wireless interface 503 can compatibly communicate on any of a variety of proprietary and public wireless resources as desired. Examples include cellular telephony for data, satellite-based communications, long-range Wi-Fi, push-to-talk-based technologies, and so forth.

This unmanned aerial vehicle 105 includes one or more cargo areas 504. As used herein, a “cargo area” is a part of the unmanned aerial vehicle 105 that is configured to retain/hold a package that is not an ordinary part of the unmanned aerial vehicle 105 and that is to be delivered to a recipient address/location. Accordingly, a “cargo area” can comprise a partially or wholly contained space within the unmanned aerial vehicle 105 that receives the package during transit. The “cargo area” can also comprise, however, an external area where the package is located during transit while tethered in some manner to the unmanned aerial vehicle 105 (via, for example, straps, netting, hooks, or the like). (As used herein, a “package” will be understood to comprise a physical item that is being delivered to a particular recipient as part of fulfilling an order for that recipient.)

Having this cargo area 504, it will be understood that the unmanned aerial vehicle 105 itself constitutes a cargo-carrying unmanned vehicle to serve in a package delivery service role. More particularly, it will be understood that the primary operational purpose of this unmanned aerial vehicle 105 is to carry cargo and to convey one or more packages to one or more recipient addresses/locations. Those skilled in the art will recognize that the foregoing constitutes a significant design goal and constraint. In particular, weight is a significant concern for any airborne vehicle as the vehicle will necessarily have a maximum load-carrying ability and every ounce that the unmanned aerial vehicle 105 necessarily includes as part of itself is an ounce that subtracts from the maximum-sized package that the unmanned aerial vehicle 105 can carry. Therefore, and generally speaking, an unmanned aerial vehicle 105 that is configured to carry, as a primary operational purpose, one or more packages to be delivered will avoid including components and accoutrements that do not directly support that primary operational purpose of carrying and delivering a package.

Being an unmanned aerial vehicle, the unmanned aerial vehicle 105 will include components/resources that are essential to its ability to fly. Examples in these regards include a power source, a motive mechanism (such as one or more motorized propellers), one or more steering mechanisms (capable, in the aggregate, of controlling movement with respect to pitch, roll, and yaw), a housing/fuselage, landing gear, and so forth). In addition, the unmanned aerial vehicle 105 can include other resources that are not directly related to that flight capability.

As one example in these regards, the unmanned aerial vehicle 105 includes at least one primary task camera 505. This primary task camera 505 may be a still-image camera or a video camera (which may itself be capable of capturing a single still image) as desired. To be a “primary task” camera this camera 505 is configured and employed by the control circuit 501 to support the primary task. This can comprise, for example, capturing images of a package in transit to monitor and/or confirm the safe passage of the package during flight. This can also comprise, for example, capturing images that are used to help the unmanned aerial vehicle 105 correctly and safely navigate to the targeted recipient address/location. As yet another example this can comprise capturing images at the target recipient address/location to confirm, for example, the facial identity of the recipient, that the package was left in a certain condition in a certain location, and/or other local features/fields of view that pertain to the accurate, safe, and undamaged delivery of the package.

By one approach the unmanned aerial vehicle 105 can also include one or more secondary task cameras 506. Again, this camera 506 can be still image or video cameras as desired. Being “secondary task” cameras, these cameras 506 are not ordinarily employed (or possibly are never employed) in support of the primary task and hence are tasked differently than the above-described primary task camera 505. At a minimum, then, the absence or operational failure of a secondary task camera 506 will have no bearing or effect upon the ability of the unmanned aerial vehicle 105 to properly convey and/or deliver a package to a target recipient.

The “secondary task” can be essentially anything other than the task of supporting and facilitating the conveyance and delivery of the package being delivered as a primary task by the unmanned aerial vehicle 105. By one approach that secondary task can be capturing content exclusively in support of the teachings provided herein. By another approach that secondary task can include capturing content for any of a variety of tasks other than conveying/delivering packages.

Also if desired, the unmanned aerial vehicle 105 can include one or more sensors 507. Such a sensor 507 may or may not be in support of the aforementioned primary task as desired. As one example, when the sensor 507 comprises a rain sensor, the unmanned aerial vehicle 105 may employ that sensor to determine whether it is presently raining and hence whether to leave a delivered package in an open, exposed area (in which case the sensor 507 comprises a primary task sensor).

So configured the control circuit 501 can transmit, selectively or in bulk as desired, and essentially in real time or otherwise as desired, content captured by one or more of the aforementioned primary task camera 505, secondary task camera 506, and/or the sensor 507 via the wireless interface 503 to be eventually received by the aforementioned control circuit 101.

Accordingly, by one approach, content captured by a primary task camera 505 can be conveyed to that control circuit 101 to be shared as described herein notwithstanding that the content was captured as part of the primary task camera's 505 functioning in support of conveying/delivering a package. As another example, when the primary task camera 505 is not being actively utilized in support of the primary task, the control circuit 501 may temporarily differently task that camera 505 to capture content in service of a secondary task of interest (for example, by aiming, panning, tilting, or zooming the camera's image capturing components to capture particular content of secondary interest).

As noted above, the unmanned aerial vehicle 105 is physically configured to carry out a primary task (in these illustrative examples, a package delivery service). Accordingly, the various resources described above are, at least for the most part, provided to serve that primary purpose. Supplemental resources and/or diversion of those resources from the primary task will typically not occur without collateral costs. Examples of such costs include reduced cargo-carrying capacity and reduced battery life/operating range.

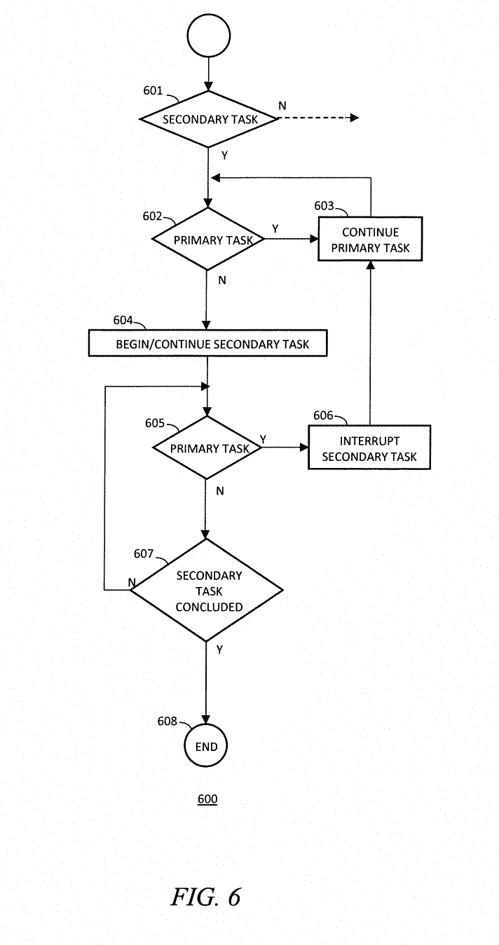

FIG. 6 presents one approach to prioritize the needs of the primary task in favor of the needs of any secondary tasks. Pursuant to this process 600, upon determining at block 601 that a secondary task is available to process, this process 600 then responsively determines, at block 602, whether a primary task is already (or, if desired, imminently) in process. As one illustrative example, a secondary task may arrive via the wireless interface 503 that requires using the primary task camera 505 to capture a particular requested image/field of view. The foregoing steps provide, in that case, for determining whether the primary task camera 505 is already being used in favor of the primary task. When true, at block 603 this process 600 provides for automatically continuing the primary task's usage of the on-board resource and for concurrently denying any use of that resource (such as use of the primary task camera 505) in favor of the pending secondary task.

When there is no current primary task usage of the on-board resource that is needed for the secondary task, block 600 for this process 600 provides for beginning that secondary task. While that secondary task receives attention, however, this process 600 provides for determining, at block 605, whether a primary task need for the resource in question has arisen prior to conclusion of the secondary task. By one approach the control circuit 501 periodically checks for such a state. By another approach an interrupt mechanism can serve to almost immediately recognize such a state. When the foregoing occurs, at block 606 this process 600 provides for interrupting the secondary task and diverting use of the necessary resource(s) in favor of the primary task. Continuation of the secondary task will then be delayed until the primary task's use of the necessary resource(s) concludes.

When the secondary task eventually concludes (as detected at block 607) this process 600 can end (680). So configured, on-board resources can be shared in favor of secondary tasks without compromising the needs of the primary task.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
at least one unmanned aerial vehicle configured to carry out a primary task, wherein the unmanned aerial vehicle includes:
at least one on-board resource that is not directly related to flight capability but that is used to carry out the primary task;
a control circuit configured to prioritize use of the at least one on-board resource to favor the primary task as compared to any secondary task;
a network interface;
a control circuit operably coupled to the network interface and configured to:
receive informational content from the at least one unmanned aerial vehicle that is sourced by the at least one on-board resource as a secondary task;
automatically process the informational content to identify specific content;
automatically submit, via the network interface, the specific content to a social networking service to publicly share as social media.

2. The apparatus of claim 1 wherein the primary task comprises delivering packages to a recipient on behalf of a retail shopping service.

3. The apparatus of claim 1 wherein the network interface comprises, at least in part, an Internet connection.

4. The apparatus of claim 1 wherein the informational content includes at least one of:
textual content;
still-image content;
video content;
audio content;
atmospheric-conditions content.

5. The apparatus of claim 1 wherein the control circuit is configured to receive the informational content from the unmanned aerial vehicle, at least in part, via a wireless transmission.

6. The apparatus of claim 1 wherein the control circuit is configured to automatically process the informational content to identify the specific content by, at least in part, using selection criteria provided to the control circuit via the social networking service.

7. The apparatus of claim 1 wherein the control circuit is configured to automatically submit, via the network interface, the specific content to the social networking service at least at one of:
regular predetermined intervals;
a predetermined number of times per day.

8. The apparatus of claim 1 wherein the control circuit is configured to automatically submit, via the network interface, the specific content to the social networking service to publicly share as social media by submitting the specific content on behalf of the unmanned aerial vehicle.

9. The apparatus of claim 8 wherein the unmanned aerial vehicle has an individualized presence on the social networking service and wherein the control circuit submits the specific content on behalf of the unmanned aerial vehicle by submitting the specific content via the individualized presence on the social networking service.

10. The apparatus of claim 1 further comprising a plurality of unmanned aerial vehicles and wherein the control circuit is further configured to:
receive informational content from each of the plurality of unmanned aerial vehicles;
automatically process the informational content from each of the plurality of unmanned aerial vehicles to identify specific content from more than just one of the plurality of unmanned aerial vehicles;
automatically submit, via the network interface, the specific content from more than just one of the plurality of unmanned aerial vehicles to a social networking service to publicly share as aggregated social media.

11. A method for use with at least one unmanned aerial vehicle configured to carry out a primary task, wherein the unmanned aerial vehicle includes:
at least one on-board resource that is not directly related to flight capability but that is used to carry out the primary task; and
a control circuit configured to prioritize use of the at least one on-board resource to favor the primary task as compared to any secondary task, the method comprising:
by a control circuit that is operably coupled to a network interface:
receiving informational content from the at least one unmanned aerial vehicle that is sourced by the at least one on-board resource as a secondary task;
automatically processing the informational content to identify specific content;
automatically submitting, via the network interface, the specific content to a social networking service to publicly share as social media.

12. The method of claim 11 wherein the primary task comprises delivering packages to a recipient on behalf of a retail shopping service.

13. The method of claim 11 wherein the network interface comprises, at least in part, an Internet connection.

14. The method of claim 11 wherein the informational content includes at least one of:
textual content;
still-image content;
video content;
audio content;
atmospheric-conditions content.

15. The method of claim 11 wherein receiving the informational content from the unmanned aerial vehicle comprises, at least in part, receiving the informational content via a wireless transmission.

16. The method of claim 11 wherein automatically processing the informational content to identify the specific content comprises, at least in part, using selection criteria provided to the control circuit via the social networking service.

17. The method of claim 11 wherein automatically submitting, via the network interface, the specific content to the social networking service comprises, at least in part, submitting the specific content at least at one of:
regular predetermined intervals;
a predetermined number of times per day.

18. The method of claim 11 wherein automatically submitting, via the network interface, the specific content to the social networking service to publicly share as social media comprises submitting the specific content on behalf of the unmanned aerial vehicle.

19. The method of claim 18 wherein the unmanned aerial vehicle has an individualized presence on the social networking service and wherein submitting the specific content on behalf of the unmanned aerial vehicle comprises submitting the specific content via the individualized presence on the social networking service.

20. The method of claim 11 further comprising:
receiving informational content from each of a plurality of unmanned aerial vehicles;
automatically processing the informational content from each of the plurality of unmanned aerial vehicles to identify specific content from more than just one of the plurality of unmanned aerial vehicles;
automatically submitting, via the network interface, the specific content from more than just one of the plurality of unmanned aerial vehicles to a social networking service to publicly share as aggregated social media.
